(19) United States
(12) Patent Application Publication
(10) Pub. No.: US 2023/0057487 A1
(43) Pub. Date: Feb. 23, 2023

(54) DATA PACKET FORMAT TO COMMUNICATE ACROSS DIFFERENT NETWORKS

(71) Applicant: HUAWEI TECHNOLOGIES CO., LTD., Shenzhen (CN)

(72) Inventors: Renwei Li, Santa Clara, CA (US); Kiran Makhijani, Los Gatos, CA (US); Lijun Dong, San Diego, CA (US)

(73) Assignee: HUAWEI TECHNOLOGIES CO., LTD., Shenzhen (CN)

(21) Appl. No.: 17/970,944

(22) Filed: Oct. 21, 2022

Related U.S. Application Data
(63) Continuation of application No. PCT/US2020/057962, filed on Oct. 29, 2020.
(60) Provisional application No. 63/020,976, filed on May 6, 2020.

(51) Int. Cl. H04L 45/741; H04W 40/24

(52) U.S. Cl. CPC H04L 45/741; H04W 40/24

(57) ABSTRACT

The present technology discloses data communication in a network. A node in the network receives an internet protocol (IP) data packet. The IP data packet has a header and a payload. The node performs actions on the IP data packet based on specifications in the header of the IP data packet. The node then forwards the IP data packet based on the specifications in the header of the IP data packet to a next hop node in the network.

### CLAIM OF PRIORITY

This application is a continuation of, and claims priority to PCT Patent Application No. PCT/US2020/057962, entitled “DATA PACKET FORMAT TO COMMUNICATE ACROSS DIFFERENT NETWORKS”, filed Oct. 29, 2020, which claims priority to U.S. Provisional Patent Application No. 63/020,976, filed May 6, 2020, which applications are incorporated by reference herein in their entirety.

### FIELD

This disclosure generally relates to data transmission in a network.

### BACKGROUND

For packet-based network architectures, a data packet is the fundamental unit upon which different actions such as classification, forwarding or discarding are performed by network nodes in the network. The Internet Protocol (IP), the principal communication protocol used by the Internet, has a data packet format with a fixed size IP header that carries address and control information, followed by a payload. Such data packet formats are suitable for best-effort forwarding for applications that involve the exchange of data for human consumption (e.g., websites, multimedia, human-driven machine operators, etc.). The fixed header format may result in transmission overheads when the control information is small and can be limiting when information required by a desired network service cannot fit into the header. Different schemes to extend information in data packets include tunnels and extension headers.

### SUMMARY

According to one aspect of the present disclosure, there is a method for data communication in a network, comprising receiving, by a node in the network, an internet protocol (IP) data packet, the IP data packet having a header and a payload; performing, by the node, an action on the IP data packet based on specifications in the header of the IP data packet; and forwarding, by the node, the IP data packet based on the specifications in the header of the IP data packet to a next hop node in the network.

Optionally, in any of the preceding aspects, the data packet has a format including a header field and the specifications, and the specifications include a shipping specification field, a contract specification field and a payload specification field.

Optionally, in any of the preceding aspects, each of the shipping specification field, the contract specification field and the payload specification field are independently variable in length.

Optionally, in any of the preceding aspects, the header field specifies an offset of the shipping specification field, an offset of the contract specification field, an offset of the payload specification field, and the length of the payload.

Optionally, in any of the preceding aspects, the shipping specification field specifies one or more address format types, a source address (SA) field and a destination address (DA) field, wherein the SA and DA fields specify at least one of a length of the address, a type of communication and the SA and DA.

Optionally, in any of the preceding aspects, the one or more address format types comprise one or more of an IPv4, IPv6, MPLS or a geo-coordinate type address.

Optionally, in any of the preceding aspects, the length of the address of the SA and DA is variable.

Optionally, in any of the preceding aspects, each contract specification field includes one or more contract clauses, and each contract clause includes at least one of an event and a condition, and the action.

Optionally, in any of the preceding aspects, the method further comprising executing the action in the contract clause upon occurrence of the event specified in the contract clause and when the condition specified in the contract clause is satisfied.

Optionally, in any of the preceding aspects, the contract clause includes the event, the condition and the action; the event indicates the occurrence or state of a node in the network that impacts behavior of the network; the condition indicates one or more logical operators to perform a conditional check upon occurrence of the event; and the action indicates IP data packet forwarding or processing commands.

Optionally, in any of the preceding aspects, the payload specification field specifies a differentiated value or property corresponding to portions of the payload.

Optionally, in any of the preceding aspects, the action corresponds to an operation performed on the payload based on the differentiated value or property in the payload specification.

Optionally, in any of the preceding aspects the property specifies a relationship between different portions of the payload.

Optionally, in any of the preceding aspects, the method further comprising performing the action on portions of the payload according to the condition and the action and the property corresponding to portions of the payload in the contract clause.

Optionally, in any of the preceding aspects, the actions are specific to each of the portions of the payload.

Optionally, in any of the preceding aspects, the property specifies the differentiated value corresponding to the portions of the payload, and the property includes a flag that indicates that the action has been performed on one or more of the portions of the payload.

Optionally, in any of the preceding aspects, the condition includes at least one of a transmission error, congestion level or cyclic redundancy check (CRC) error.

According to one aspect of the present disclosure, there is a node for communicating data in a network, comprising a non-transitory memory storage comprising instructions; and one or more processors in communication with the memory, wherein the one or more processors cause the node to execute the instructions to receive an internet protocol (IP) data packet, the IP data packet having a header and a payload; perform an action on the IP data packet based on specifications in the header of the IP data packet; and forward the IP data packet based on the specifications in the header of the IP data packet to a next hop node in the network.

According to one aspect of the present disclosure, there is a non-transitory computer-readable medium storing computer instructions for data communications in a network, that when executed by one or more processors, cause the one or more processors to perform the steps of receiving, by a node in the network, an internet protocol (IP) data packet, the IP data packet having a header and a payload; performing, by the node, an action on the IP data packet based on specifications in the header of the IP data packet; and forwarding, by the node, the IP data packet based on the specifications in the header of the IP data packet to a next hop node in the network.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

Aspects of the present disclosure are illustrated by way of example and are not limited by the accompanying figures for which like references indicate like elements.

FIG. 1 illustrates an embodiment of a network environment suitable for use with the present technology.

FIG. 2A illustrates a New IP header and data format in a data transmission framework.

FIG. 2B illustrates an example New IP packet in an Ethernet Frame.

FIG. 3 illustrates an example flow diagram for receiving and forwarding data packets in the network of FIG. 1.

FIG. 4A illustrates an example shipping specification of the new IP data packet in FIG. 2.

FIG. 4B illustrates an example of addressing cast and types in the shipping specification field of FIG. 4A.

FIG. 4C illustrates an example of addressing providing backward compatibility.

FIG. 5A illustrates an example contract specification field in the new IP data packet of the present technology.

FIG. 5B illustrates an example of a contract clause in the contract specification field of FIG. 5A.

FIG. 5C illustrates an example of actions that may be specified in a contract clause.

FIG. 5D illustrates an example of events and conditions that may be specified in a contract clause.

FIG. 6A illustrates an example embodiment of the payload specification field of the new IP data packet of the present technology.

FIG. 6B illustrates an example data format for a qualitative services data transmission framework.

FIG. 7 illustrates an embodiment of a network node comprising a router.

FIG. 8 illustrates a schematic diagram of a general-purpose network component or computer system.

### DETAILED DESCRIPTION

The present disclosure will now be described with reference to the figures, which in general relate to transmission of data in a network.

The Internet Protocol (IP) is the primary data plane protocol on the Internet. The present disclosure builds upon the existing IP structure and formalizes a new data packet (termed “New IP data packet”) to help modernize the overall structure of packets by introducing three types of characteristics, each solving a specific class of problem in networks (e.g., fixed structure of packets). This new IP data packet has a new IP header that is formatted to include a new IP shipping specification, a new IP contract specification and a new IP payload specification. The new IP shipping specification allows for different types and formats of address based on the functionality and network connecting devices. The new IP contract specification enables a variety of services, as well as their operational and administrative control. The new IP payload specification associates network semantics to user data while maintaining payload integrity.

It is understood that the present embodiments of the disclosure may be implemented in many different forms and that claims scopes should not be construed as being limited to the embodiments set forth herein. Rather, these embodiments are provided so that this disclosure will be thorough and complete and will fully convey the inventive embodiment concepts to those skilled in the art. Indeed, the disclosure is intended to cover alternatives, modifications and equivalents of these embodiments, which are included within the scope and spirit of the disclosure as defined by the appended claims. Furthermore, in the following detailed description of the present embodiments of the disclosure, numerous specific details are set forth in order to provide a thorough understanding. However, it will be clear to those of ordinary skill in the art that the present embodiments of the disclosure may be practiced without such specific details. For example, although the previous paragraph describes three new specification types, the disclosure also includes embodiments where only one or two of the three specification types are included.

Internet Protocol (IP) is a fundamental building block of current data plane technologies in networks. Additional transport and routing protocols are developed with the assumption of having IP as a network-level packet format. While IP is well suited for traditional terminals and web-based applications, recent initiatives such as FG-NET-2030, emerging industry verticals, and applications in 5G and Beyond 5G (B5G) have identified limitations with IP in its current format. To accommodate these advances, data plane network technologies require additional capabilities to handle applications in many of the industry verticals, such as robotics-based automation and cloud-assisted driving. These industry verticals require data plane capabilities, such as guarantees of arrival times and bandwidth and assurances of security and reliability, beyond what IP currently offers.

Today's packet-switched networks have a minimal set of on-the-wire functions to support a diverse set of services. Efforts in programmability and service assurance are primarily fragmented and fail to facilitate the adoption of next-generation (5G, B5G) applications with stringent bounded latency and high throughput requirements. Moreover, the foundational network infrastructure is limited in handling the emergence of edge computing networks and space internet, both requiring dynamic topology models. In some instances, various Internet of Things (IoT) device addressing schemes do not fit in IP addressing schemes. Finally, the packet loss penalties in high data rate transmission lead to poor user experience. When the network is busy, alternate congestion responses become necessary to maintain a predictable throughput.

The lack of flexibility in the data plane often leads to an overlay-based approach or middle-box insertion that needs to be maintained along with several provisioning touchpoints in the underlay networks. This results in an increase the overall complexity and limits scalability. To provide these functionalities in IP networks, addition to IPv4 options or IPv6 extension headers is necessary, both of which are very difficult to implement using current standards.

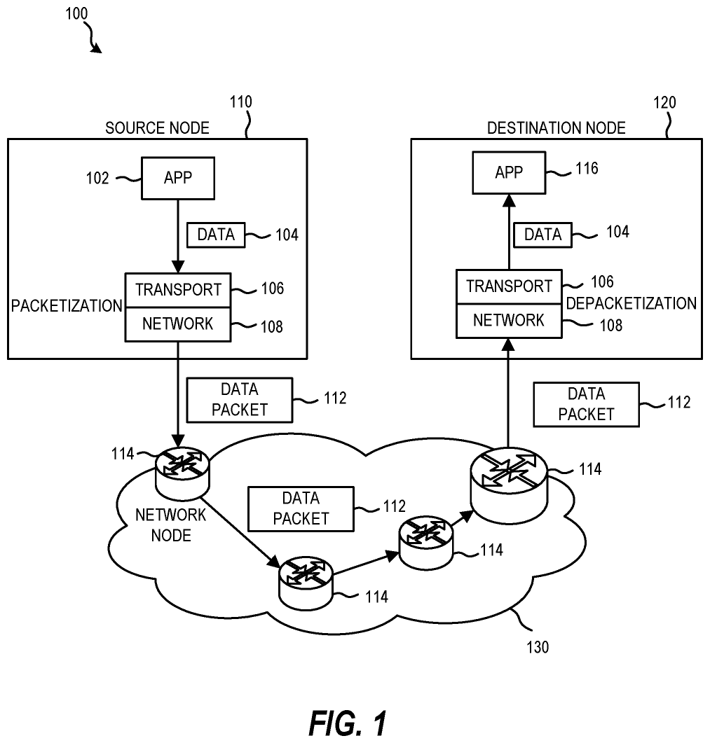

FIG. 1 is an example network for communicating data between a source node and a destination node over a communication network. The network 100 includes, for example, a source node 110, a destination node 120 and a communication network 130. The source node 110 and destination node 120 can be any type of electronic device capable of communicating over the communication network 130 such as, but not limited to, a mobile communication device, an Internet of things (IoT) device, a personal computer, a server, a router, a mainframe, a database, or any other type of user or network device. For example, the source node 110 can be a media server, and the destination node 120 can be a mobile device that receives media content from the source node 110.

In the depicted embodiment, the source node 110 executes one or more programs/applications (APP) 102. The application 102 can be any type of software application, and produces or generates data 104. Data 104 can be any type of data depending on the functions of the application 102. For example, in one embodiment, the data 104 can be data that is automatically produced and pushed by the source node 110 to the destination node 120. Alternatively, the data 104 can be data that is specifically requested from the source node 110 by the destination node 120. To communicate the data 104 to the destination node 120, the application 102 on the source node 110 uses an application programming interface (API) to communicate the data 104 to a transport layer 106 of the source node 110. The transport layer 106 is responsible for delivering the data 104 to the appropriate application 116 on the destination node 120. The transport layer 106 bundles/organizes the data into data packets 112 according to a specific protocol (i.e., packetization). For instance, the transport layer 106 may use various communication protocols such as, but not limited to, Transmission Control Protocol/Internet protocol (TCP/IP) for providing host-to-host communication services such as connection-oriented communication, reliability, flow control, and multiplexing.

The data packets 112 are transferred to a network layer 108 of the source node 110. The network layer 108 is responsible for packet forwarding including routing of the data packets 112 through one or more intermediate routers or network nodes 114 of the communication network 130. The communication network 130 can comprise multiple interconnected networks including, but not limited to, a local area network (LAN), metropolitan area network (MAN), wide area network (WAN), a wireless or mobile network, and an inter-network (e.g., the Internet). When the data packets 112 reach the destination node 120, data 104 is extracted from the data packets 112 (i.e., depacketized) and passed to the application 116 on the destination node 120.

Although FIG. 1 illustrates one example of a communication system, various changes may be made to FIG. 1. For example, the communication system 100 could include any number of source nodes, destination nodes, access points, networks, or other components in any suitable configuration.

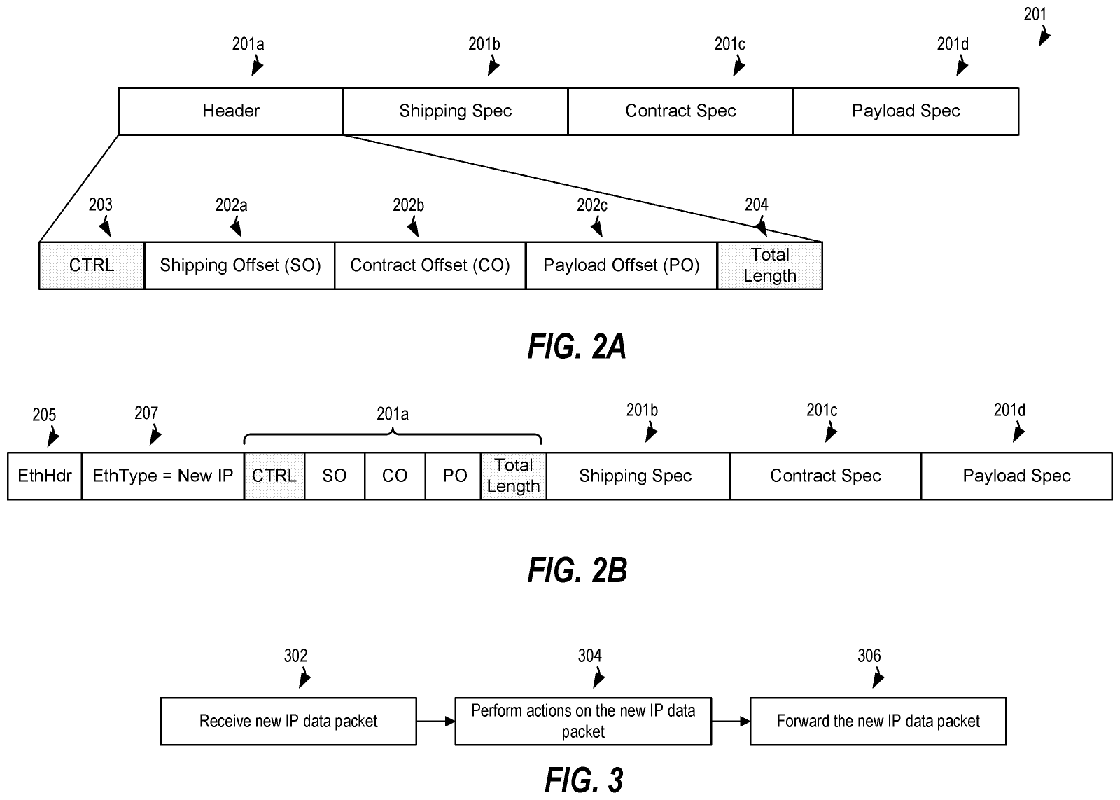

FIG. 2A illustrates a New IP header and data format in a data transmission framework. The present technology discloses a new data packet format termed “New Internet Protocol” (New IP). The new IP data packet 201 is part of an Internet framework that brings several capabilities in the present technology. New IP is a data plane technology that defines a new IP packet format, its specification, and corresponding capabilities in the network nodes. Using the present technology, new and upcoming applications, such as industrial internet, vehicle-to-infrastructure, autonomous systems, holographic type communications, etc., may be enabled over networks and across ManyNets. These new IP data packets 201 may therefore be used for data transmission over a wide variety of networks having different capabilities and requirements. However, other variations of new IP data packets are also part of this application, including the described specifications, subsets of the described specifications, and combinations of the described specifications with other specifications. These can all be collectively considered “new IP data packets” for purposes of the present disclosure.

As illustrated, the new IP data packet 201 includes a header field 201a, followed by a shipping specification field 201b, a contract specification field 201c and a payload specification field 201d. It is appreciated that the order of the specifications as illustrated is one embodiment, and that the specification may be placed in any order. It is also appreciated that additional or fewer specifications may be included in the format. For example, one format may only include the shipping specification field and the payload specification field, whereas another format may include the contract specification and payload specification field. In another example, additional specifications may be added.

The header field 201a identifies the beginning of the data packet 201 and describes offsets for the specification fields. For example, the header field 201a includes a shipping offset (or pointer) 202a of the shipping specification 201b, a contract offset (or pointer) 202b of the contract specification 201b and a payload offset (or pointer) 202c of the payload specification 201d. In one embodiment, the header field 201a may also include a signature field (CTRL) 203, such as implementation-specific details (e.g., flags) and a total length 204 of the packet. In a further embodiment, the offset of a specification and the total length of the packet may indicate whether the packet is corrupt. For example, when none of the offsets exceed the total length of the packet, the packet is not corrupt. In another example, the packet may be corrupt when one of the offsets exceeds the total length of the packet. For instance, the payload offset may be set to a length of 20 and the total length of the offsets may be set to 10. Since the payload offset length is greater than the total length of the offsets, the packet may be identified as corrupt. In another embodiment, the signature field (CTRL) may indicate whether the header has been corrupted during transit. For example, the signature field may be a hash, a cyclic redundancy check (CRC) or a public/private key mechanism. Other variations on these fields are also possible. For example, in some embodiments the payload specification 201d can include a field indicating its own length, which can be used with the offsets to compute the length of the entire packet. Similarly, in some embodiments the header 201a can include a shipping offset 202a and lengths of the shipping specification and the contract specification, instead of the contract offset and the payload offset. More generally, a combination of offsets and/or lengths of the various fields can indicate their locations and lengths in the packet.

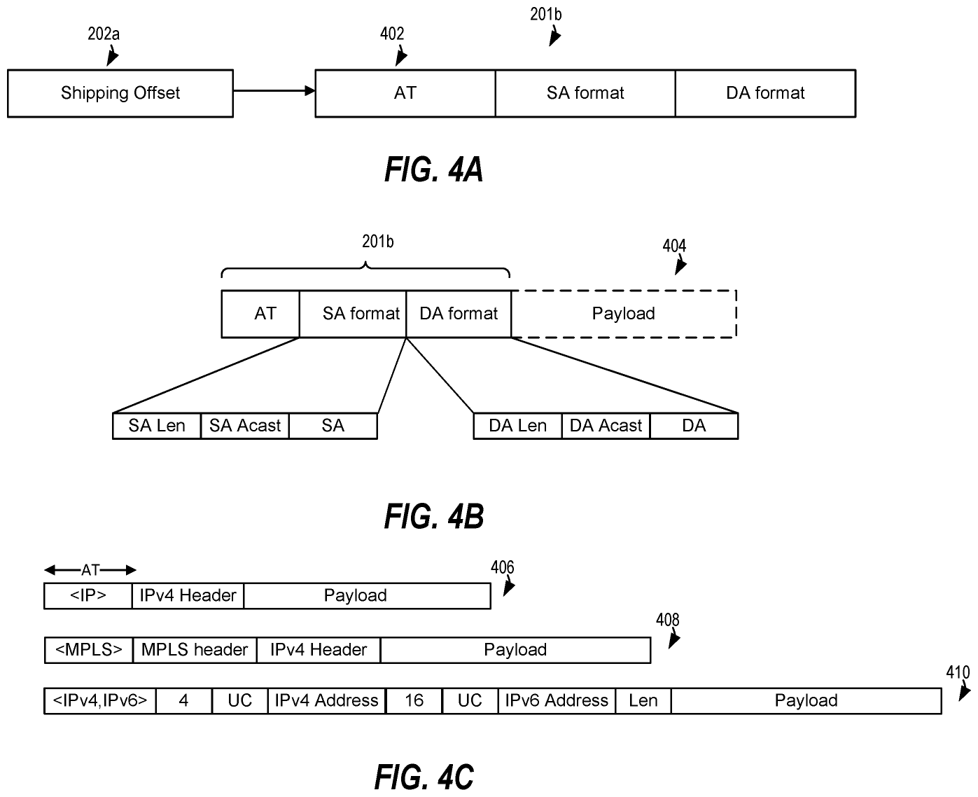

The shipping specification field 201b provides flexible and contextual addressing in heterogeneous networks and inter-networking systems. In one embodiment, the shipping specification field 201b allows for different types and formats of addresses based on the functionality and network connecting devices. In one other embodiment, the shipping specification field 201b enables backward compatibility with existing addressing schemes, such as IPv4 and IPv6. The shipping specification 201b is described in more detail below with reference to FIGS. 4A and 4B.

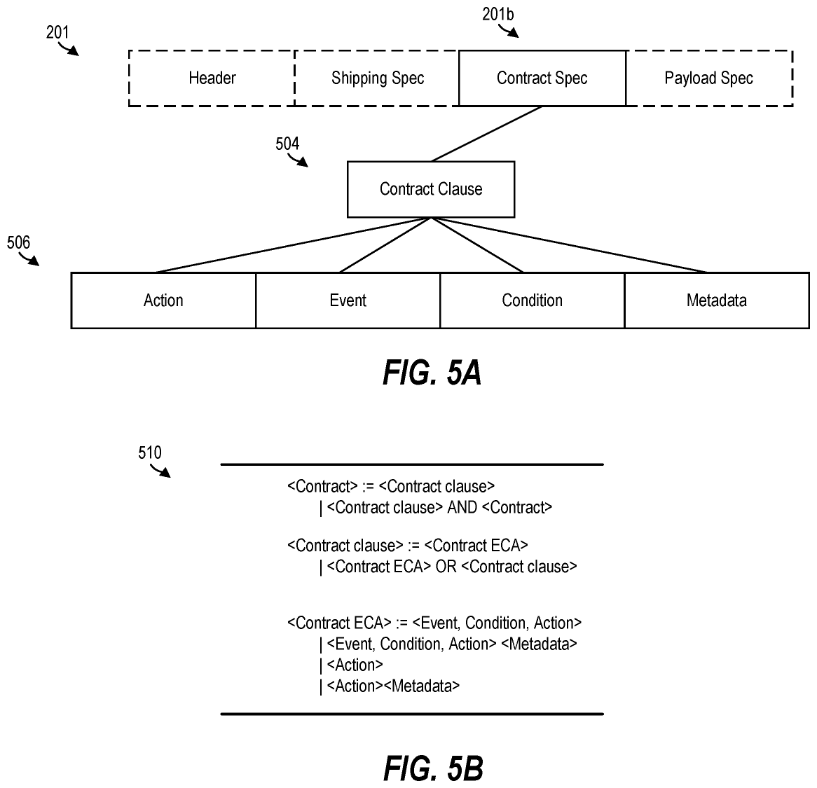

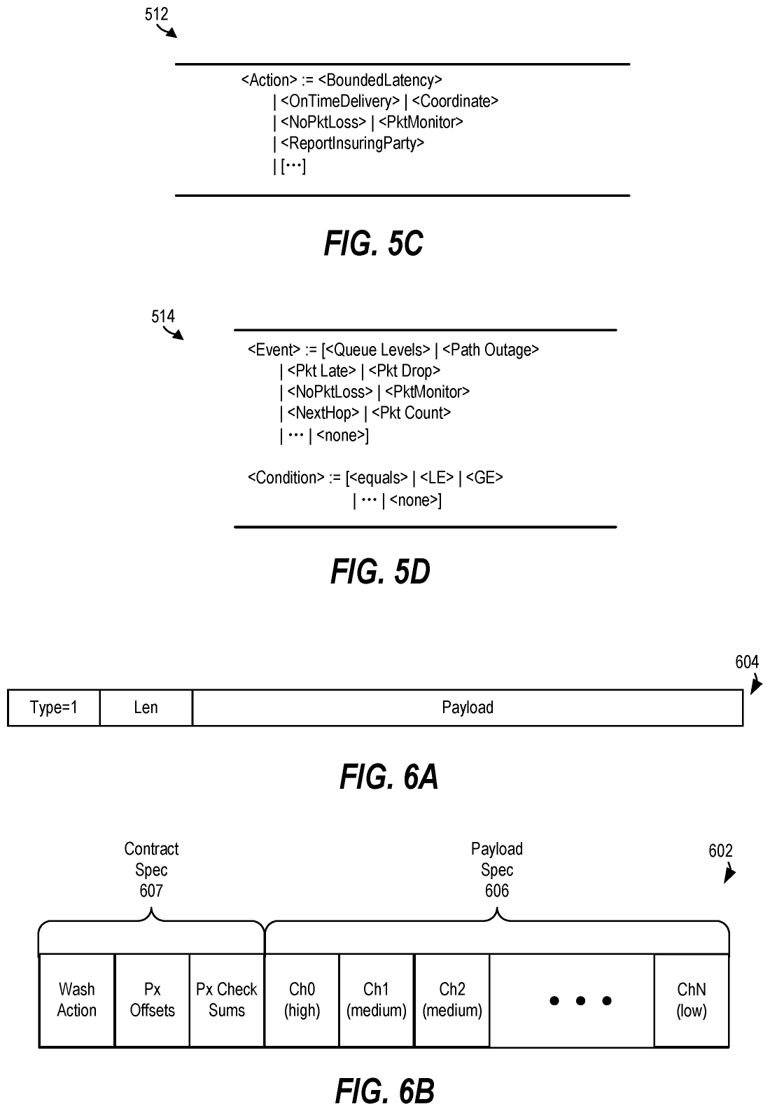

The contract specification field 201c supports service and application-awareness, where a contract (detailed below) specified in the contract specification field 201c allows for robust service delivery models and provides guarantees of Service Level Objectives (SLO) such as latency, capacity, reliability, etc. In one embodiment, the contract specification field 201c focuses on high-precision communication (HPC) and the life cycle of any type of service in the network to enable a variety of services, as well as their operational and administrative control at the finest packet-level granularity. As explained in more detail below, the contract in the contract specification field 201c create avenues for the next generation of programmability, customization and non-monolithic data plane pipelines, while also providing the ability to satisfy requirements to perform telemetry, elastically grow services on-demand and create new business models around HPC. The contract specification field 201b is described in more detail below with reference to FIGS. 5A-5D.

The payload specification field 201d specifies capabilities through which entropy and quality of information is carried in the payload and which may be used to improve throughput and achieve robustness of data transmission. In one embodiment, the payload specification field 201d associates semantics, such as user-defined or application semantics, with the user data while maintaining payload integrity. For example, when a data packet is received by a node from an end-user in the network, the data payload remains usable even if the payload does not match bit-by-bit with the payload from the sender. Rather, using the semantics associated with the user data, the receiving node may use partial information carried in the payload. This partial-packet reception helps to mitigate re-transmission overhead and delays when faced with slow or congested conditions. The payload specification 201d is described in more detail below with reference to FIGS. 6A and 6B.

Accordingly, using the various specifications, the new IP data packet 201 is flexible and may be changed or modified to suit the particular needs of a network operation or conditions presented in the network. For example, and for purposes of discussion, assume that addressing enhancements are an essential requirement in a particular network implementing the new IP data packet. To enhance addressing, an operator can deploy and manage addressing features using the shipping specification field 201b. Similarly, if a need for Beyond Best-Effort (BBE) service-aware infrastructure is more critical, then the contract specification field 201c may be deployed by the network operator. Later, as needs for payload enhancements become necessary, the payload specification field 201d may be incorporated in the network.

On example embodiment of the new IP data packet 201 is shown in FIG. 2B, which illustrates an example New IP packet 201 in an Ethernet Frame. In the depicted embodiment, an Ethernet header (EthHdr) field 205 is followed by an Ethernet type (EthType) field 207, which specifies that the type is a New IP format 201. The New IP format 201 is encapsulated by the Ethernet frame and includes a header field 201a, the shipping specification 201b, the contract specification 201c and the payload specification 201d.

FIG. 3 illustrates an example flow diagram for receiving and forwarding data packets in the network of FIG. 1. In the discussion that follows, the intermediate routers or nodes perform the procedures. The procedures discussed below with reference to FIG. 3 provide an overview of the new IP and are presented in view of the network in FIG. 1 and the data packet 201 in FIG. 2. It is appreciated that other functional units or processing units may implement the processes described herein, such that the disclosure is not limited to implementation by the routers, and similarly the processes may be implemented on other packets.

At step 302, the node receives a new IP data packet 201. The new IP data packet 201 includes a header field 201a, a shipping specification 201b, a contract specification 201c and a payload specification 201d, as discussed above.

The header field 201a specifies an offset or pointer for each of the shipping specification field 201b, the contract specification field, and the payload specification field 201d. In one embodiment, each of the shipping specification field 201b, the contract specification field 201c and the payload specification field 201d are independently variable in length. That is, the length of each specification is flexible to accommodate the information stored therein, explained in more detail below with reference to the various figures.

The shipping specification field 201b specifies address format types, a source address (SA) field and a destination address (DA) field. The SA and DA fields specify a length of the address, a type of communication and/or information related to the SA and DA format. In one embodiment, the length of the SA and DA address is variable. In one further embodiment, the address format types are the same. In another embodiment, the address format types are different. The shipping specification field 201b is explained in more detail below with reference to the various figures.

The contract specification field 201c includes one or more contract clauses. In one embodiment, the contract clause includes an event, a condition, metadata and an action. The event indicates the occurrence or state of a node in the network that impacts behavior of the network. The condition indicates one or more logical operators to perform a conditional check upon occurrence of the event. As an example, the action indicates an ‘OnTimeGuarantee delivery’ action with an additional parameter of time value of the new IP data packet 201 communicated between a source and a destination. The contract specification field 201c is explained in more detail below with reference to the various figures.

The payload specification field 201d specifies a differentiated value (e.g., different attributes or characteristics associated with portions of packets, such as a significance or a priority level of portions of the packet) or property corresponding to portions of the payload. In one embodiment, the property specifies a relationship between different portions of the payload. The payload specification field 201d is explained in more detail below with reference to the various figures.

At step 304, the node performs one or more actions on the new IP data packet 201 based on the specifications in the header. In one embodiment, the action in the contract is executed when an event specified in the contract clause occurs and/or when the condition specified in the contract clause is satisfied. In one other embodiment, the action corresponds to an operation performed on the payload based on the differentiated value or property in the payload specification.

In one embodiment, actions may be performed on one or more portions of the payload. These actions may be based on, for example, the condition, the action and the property corresponding to portions of the payload in the contract clause. In one embodiment, the actions are specific to each of the portions of the payload. In another embodiment, the condition includes one or more of a transmission error, congestion level or cyclic redundancy check (CRC) error. In another embodiment, the property specifies the differentiated value corresponding to the portions of the payload. In still another embodiment, the property includes a flag that indicates that the action has been performed on the portions of the payload. A further explanation of actions is described in more detailed below with reference to the various figures.

At step 306, the node forwards the new IP data packet 201 based on the specifications in the header to a next hop node in the network. In one embodiment, multiple versions of the IP data packet 201, each having different lengths for the various specification fields (and optionally also other differences including different payloads), may be forwarded to a next hop node in the network. In one further embodiment, the IP data packet 201 is forwarded by the node to the next hop node based on the destination address in the shipping specification field 201b. In still a further embodiment, the node may forward the new IP data packet 201 based on an action identified in specification in the header, such as at a time or manner specified by the action.

FIG. 4A illustrates an example shipping specification of the new IP data packet in FIG. 2. The format of the shipping specification field 201b provides a robust addressing scheme, including support for a flexible address format scheme, a backward compatible addressing scheme and a hybrid addressing scheme. In particular, the shipping specification field 201b allows for different types and formats of addresses based on semantics, functionality and the network connecting devices therein. The specification also enables backward compatibility with existing fixed length IP (e.g., IPv4 and IPv6) and MPLS address formats. The hybrid addressing is supported by allowing both source and destination formats to be specified independently.

As explained above, a shipping offset 202a (or pointer) points to the shipping specification field 201b and the length of the specification can be derived by computing the difference between the shipping offset 202a and the contract offset 202b within the context of the new IP data packet 201.

The shipping specification field 201b specifies address format types (AT), a SA format field and a DA format field. In one embodiment, a flexible addressing scheme may be used in which different types of address namespaces can be embedded. For example, the new IP data packet 201 can accommodate a wide variety of different addresses or addressing schemes (i.e. without requiring address translation schemes), including but not limited to, SigFox™, LoRA (long range) developed by Semtech™, legacy addresses and semantic formats such as service identifiers, location identifiers and variable-length identifiers. Accordingly, using a flexible addressing scheme, the size of the address identifier is not fixed and may be selected according to the specific requirements. For example, smaller lengths (size) may be selected for low power, low memory devices, achieving spectrum efficiency etc.

In one embodiment, the shipping specification field 201b seamlessly enables backward compatibility with legacy IP/MPLS (or other well-known packet types) using the AT field 402. Using the AT field 402 to identify the legacy addressing scheme, there is no need to install any translation when transiting from IP/MPLS to new IP data packet networks. This allows legacy packets to be carried, makes the forward migration path simpler and does not require any change to end-user applications that work with the legacy IP/MPLS stacks.

The shipping specification field 201b also supports a hybrid model in which asymmetric addresses are permitted. Using the hybrid model, the SA format and DA format can be the same or different depending on the addressing scheme being used. For example, the source can be IPv4 and the destination can be MPLS. With this capability, traffic from one provider addressing scheme are forwarded to another provider's network without any need for an end-to-end tunnel to homogenize the address space.

FIG. 4B illustrates an example of addressing cast and types in the shipping specification field of FIG. 4A. The shipping specification field 201b includes the AT, SA format and DA format (as shown in FIG. 4A), followed by a payload 404 (illustrated to show the specification shipping field 201b—other specifications might also precede the payload as further described below).

The AT of the shipping specification field 201b is similar to an indication of address family or indication for different address format types, and serves as a placeholder for a combination of address types for destination and source addresses. For backward compatibility, and with reference to FIG. 4C, the AT uses reserved indicators, such as legacy IPv4 (406), legacy IPv6, legacy MPLS (408), etc., with the remainder of the data packet comprising the conventional or legacy IP/MPLS. In one embodiment, an asymmetric address (410) may be specified in the shipping specification field 201b such that the source is a unicast IPv4 and the destination is a unicast IPv6, as shown in FIG. 4C. Otherwise, the AT can reflect a combination of source and destination address types that allows for current and/or future address type requirements. This permits new code types to be added as addresses, such as broadband in satellite networks that require geo-location-addresses having location awareness.

Turning back to FIG. 4B, in one embodiment, the SA and DA formats of the shipping specification 201b include a length (Len), an Address-cast (Acast) and an address.

The ‘Len’ is the size of the address format. Address formats can include, but are not limited to, flat or nested, variable length, geometry-based (longitude, latitude), or service-specific.

The ‘Acast’ identifies or describes the communications. These communications may be identified or described, for example, as patterns such as unicast, groupcast, multicast, one-to-one, many-to-one, anycast, broadcast, coordinated casting, etc. In one embodiment, address casting may be determined at the address format (and may be separate for source and destination addresses), which facilitates forwarding functions. In particular, address casting in the form of coordinated casting is the identification of co-flows in another time-engineered service called coordinated service, which is described in “Extended Abstract: Coordinated Communications for Next-Generation Networks,” Makhijani, K. et al., IEEE 27th International Conference of Network Protocols (ICNP), 2019, which is incorporated by reference herein in its entirety. One example of coordinated casting is a mechanism to synchronize information, such as synchronizing a virtual orchestra when all artists are remotely located in different geographical regions and with a different set of network conditions.

The SA and DA formats optionally provide any other information specific to the address format. As appreciated, the SA and DA contain the source address and destination address in the appropriate formats (e.g., IPv4 format). However, the source and destination formats can belong to different address spaces and have identifiers from that address space.

FIG. 5A illustrates an example contract specification field in the new IP data packet of the present technology. The new IP data packet format 201 is described above with reference to FIG. 2. The current embodiment focuses on the contract specification field of the new IP data packet format 201.

The contract specification field 201b enables a large selection of network capabilities, their functioning and regulative control at the finest packet-level granularity. The contract specification 201b may include several contract clauses 504. The contract clause 504 independently defines service specific actions, events and conditions. Production rules for a contract may be represented in a context-free grammar style, as shown in FIG. 5B. Contract clause functionality, before the present technology, is described in “A New Framework and Protocol for Future Networking Applications,” Li, R. et al., ACM Sigcomm Workshop on Networking for Emerging Applications and Technologies (NEAT 2018), the entire contents of which are incorporated herein. The network 130 and routers 114 fulfill the contract 510, assuming the contract is agreed to by the packet sender (e.g., sending computing device 110) and the packet receiver (e.g., receiving computing device 120) and the network 130. The contract 510 describes a formal service-specific arrangement between two or more parties, which includes one or more contract clauses 504 to describe the type of network service capability, actions and accounting information. In one embodiment, the contract 510 is a fixed length. In another embodiment, the contract 510 is variable in length. In the case of more than one contract 510, the location of the contract 510 may be determined by a list of offsets associated with each contract 510.

Through use of the contracts 510, service assurance requirements at a packet level are provided. In particular, a contract 510 carries any combination of specific attributes associated with time-engineered services, high-throughput media services, mission-critical ultra-reliable services and other services. In one embodiment, the structure of the contract 510 is defined in a Chomsky style. For example, a contract 510 can follow one or more contracts 510, where a contract consists of one or more contract-clauses 504 and each contract clause 504 can be in one of the following formats: (1) event, condition, action (ECA); (2) event, condition, action, metadata; (3) action only; or (4) action and metadata. Compared to traditional QoS, contracts 510 operate at much lower-level—per packet, and instruct in high-level abstract commands.

Each contract clause includes an action, and may optionally include a combination of an event, condition (together shown as event, condition, action (ECA) 506) and metadata. Similar to the entire contract 510, the event, condition, action and metadata of the contract may also be a fixed length or a variable length. In one embodiment, an atomic contract ECA exists in which the event and condition are empty. In other embodiments, a contract can omit the event, condition, and/or metadata fields. A contract clause 504 describes how the routers 114 treat the packet as it traverses the network 130 based on the event and condition, which may be predefined. Given a predefined event and condition has occurred, various actions are processed by the routers 114. For example, in order to support ultra-reliable low latency (uRLLC) in 5G, two contracts C1 and C2 may be used, where the C1 contract clause indicates a BoundedLatency action and the C2 contract clause has a NoPktLoss action (i.e., the conditions of latency bounded to a low latency, and reliability achieved through no packets being lost, are both to be met). Actions are described below with reference to FIG. 5C below.

The optional metadata contains data about the packet, e.g. accounting information, customized statistics about the flow on intermediate hops, the contextual information about the user and application, etc. The in-network node intelligence is naturally embedded and supported by the New IP framework.

FIG. 5C illustrates an example of actions that may be specified in a contract clause. An action set includes one or more actions 512 defined in the contract specification field 201c that is known and processed by all new IP nodes (e.g., nodes capable of processing new IP data packets). For example, applications 102 will insert operator-defined and/or application-defined actions. These actions 512 may be generally categorized into operations, monitoring, telemetry or signaling. New contracts as defined in the specification may be implemented across different hardware platforms using different methods or algorithms. However, the result of implementation leads to packet delivery guarantees between the sender and the receiver. Several actions are described below (some of which are shown in action 512):

Action BoundedLatency(t) (also referred to herein below as “InTimeGuarantee”) instructs the router to deliver a packet any time before the t (with prescribed unit of time). It may use corresponding metadata to describe an end-to-end network latency or available latency since transmission starts from the sender. An algorithm called latency-based forwarding (LBF) implements this action. Instead of a class of services, contract clauses embed exact parameters and objectives in the packet. The LBF algorithm is disclosed in A. Clemm, T. Eckert, “High-Precision Latency Forwarding over Packet-Programmable Networks,” IEEE/IFIP Network Operations and Management Symposium, 2020, which is incorporated by reference herein in its entirety.

Action OnTimeDevliery(t,t′) with metadata t and t′ as a total end-to-end time and elapsed time respectively delivers packet at a specific time in order to accommodate very low values of time-jitter.

Action Coordinate enables multi-user applications to adjust packet delivery timings in the network. The action needs to identify co-flows, which is actually done from the address casting part of the Shipping Spec along with timing dependency parameters as specified in metadata. For an explanation, see K. Makhijani, H. Yousefi, K. K. Ramakrishnan and R. Li, “Extended Abstract: Coordinated Communications for Next-Generation Networks,” 2019 IEEE 27th International Conference on Network Protocols (ICNP), 2019, which is incorporated by reference herein in its entirety.

Action NoPacketLoss instructs networks to use every means available to deliver the packet.

Action PreferredPath may instruct the nodes to use a set of node addresses or other forms of path identifiers embedded in the packet to provide guarantees that the packet is transmitted along that set of node addresses or identified paths.

Action PktTrace tracks the packet flow behavior across the network and may be used to understand the end-to-end service assurance and performance degradations in particular. For example, in order to understand hop-by-hop latency, PktTrace action may capture a path in the network along with the time spent in each node. An end user initiates a contract with a PktTrace action and event indicating ‘measure time.’ Each node in end-to-end path then inserts its own identification and time spent in the metadata of the packet. Similarly, if the PktTrace action is used without any event, then metadata inserted by the node is an identifier. In this way, the service knows the path taken by the packet.

Action PktMonitor helps gain visibility into the current state of the system. This action captures events in a network relating to queue thresholds, packet drops, etc. Such actions identify situations such as congestion before they occur by monitoring the thresholds. For example, in order to identify real-time congestion, if a queue at a node is built up to 70%, then this action sets the corresponding metric value in the metadata of the packet, so the information can be retrieved later.

Action ReportInsuringParty is an operator driven action to be executed when a service objective violation occurs; the node in error is then required to report such violations to the insuring party. Operators use this for the assessment of damages due to service level objectives violations, which may help build trust between different network systems.

FIG. 5D illustrates an example of events and conditions that may be specified in a contract clause. A contract clause 504 can specify when an action is executed. In particular, actions may be executed upon occurrence of an event and/or a condition.

Events are local occurrences or a state of a network node that can impact the behavior of a packet or flow in transit. Events such as queue levels, path change, drops, etc. determine congestion or fault, while other events may be operands, such as a packet count, next hop, etc. that meet a specific value.

Conditions are arithmetic or logical operators to perform conditional checks. For example, a condition may be set as less than or equal (LE) and greater than or equal (GE). These conditions may be used to check against thresholds, data rates or any other measure. Several other logical operators, such as OR, XOR, AND, may also be used to derive the results from events and actions. For example, an action may be executed when a queue level (event) is greater than or equal to (condition) a specified threshold.

FIG. 6A illustrates an example embodiment of the payload specification field of the new IP data packet of the present technology. The payload specification field 201d associates semantics to the new IP data packet payload. The payload provides options to the receiving computing device 120 to consume any residual information in the payload while allowing the network to drop portions of the payload when one or more conditions (e.g., congestion) occurs. This type of communication is referred to as a qualitative communication, which helps to mitigate re-transmission overheads and delays when faced with slow or congested conditions.

A payload that can be subjected to qualitative communications is called a qualitative payload. A qualitative payload requires additional control information. The payload specification 201d supports both simple and qualitative payloads. To support a qualitative payload, the payload specification 201d uses the contract specification 201c to carry control information. As shown in FIG. 6A, the diagram illustrates a qualitative payload including type and length (LEN). A specific example of qualitative communication will be described below with reference to FIG. 6B. It is also appreciated that the payload is not limited to the depicted embodiments. In addition to the embodiment of FIG. 6A (showing type and length), the payload specification 201d may indicate only the length of a payload, the length and type of the payload, only the type of the payload, the type of the payload with a payload contract, etc.

The payload specification field 201d allows a payload in the new IP data packet 201 to carry additional context without exposing private information in the transmitted data. In one embodiment, the payload can be a traditional payload of a sequence of bits/bytes (when ‘type’ is set to 0), or a qualitative payload that carries quality, entropy or semantics of the payload (when ‘type’ is set to 1). Payloads are subjected to qualitative communication service processing when one or more corresponding events occur, for example as described in a contract. In one embodiment, the context determines how significant a particular piece of information is within the payload. For example, a media frame can be arranged in such a manner that the initial part of the payload is the most significant frame, and the middle and last part enhance the resolution of the significant frame, such that the initial part is more important than the middle and last part.

FIG. 6B illustrates an example data format for qualitative services in new IP. While the technology will be described with respect to one example of a payload structure, it should be understood that other transport formats may be modified in accordance with the teachings herein.

In the depicted example, the new IP data packet 602 (only a portion of the packet shown) includes a contract specification 607 and a payload specification 606. The payload specification 606 embodies a qualitative payload for qualitative services (QS) and includes chunks of data (Ch0, Ch1, Ch2 . . . ChN) of a payload. The contract specification 607 includes a ‘wash’ action, Px offsets and Px check sums. In one embodiment, the contract specification 607 is used to identify the chunks of data in the payload specification 606. In a further embodiment, positions of the data chunks may be identified by offsets in the priority level Px offsets field of the contract specification 607. Additionally, the contract specification 607 may include a checksum or cyclic redundancy check (CRC) for different chunks of data so that the integrity of the new IP data packet 602 may be verified, even after a QS packet drop operation. In one embodiment, packet-level checks may be disabled and replaced by chunk-level checks. Similar information can also optionally be included in the payload specification 606, instead of the contract specification 607.

In one embodiment, each chunk of data has a significance factor (or priority-level) associated with it. As depicted, three priority levels are shown: High, Medium, and Low. While three priority levels are illustrated, it should be recognized that any number of priority levels may be utilized in accordance with the technology. The significance factor is assigned by a transmitting application on a sender network enabled device. The contract specification 607 indicates the relative data priority or significance assigned by the data transmitting application in the Px offsets field. For example, the contract specification 607 can indicate different significance factors or priority levels of each chunk of data in the payload, and how to identify the payload chunks of data associated with these priority levels (i.e. by using an offset). In one embodiment, to identify the chunks of data, the contract specification 607 specifies a specific offset for each chunk of data. While using offsets is one manner in which the chunks of data in the payload may be identified, any suitable means of communicating the location and size of the chunks of data in the new IP data packet 201 are suitable for use in accordance with the present technology.

In a further embodiment, the significance factor information may be associated with each chunk of data and may be used to manage traffic. In one embodiment, using a wash operation, chunks of data with a lower significance factor may be dropped by a network node in the case of a network condition, such as network congestion or dwell time of a packet, being detected. In one other embodiment, lower priority chunks of data in low priority packets may be dropped first (until low priority packets are entirely dropped), then lower priority chunks of data in medium priority packets, etc., depending on the priority of the chunk of data and that of the packet. While three priority levels are shown, the number of priority levels may be based on the network and application. For instance, in a data center, it is sometimes beneficial to cut the payload and only forward the header. This is due to the use of shallow buffers in order to speed up communications. In networks where buffers would fill up more slowly, more priority levels can be supported.

In one example, applying the wash action, the chunks of data in the payload may be washed to remove or drop one or more of the chunks of data in the payload. For example, the chunks of the payload may be washed and dropped, beginning with the lowest priority chunk ChN such that the remaining payload can be forwarded. In a further example, using the contract specification 607 during high congestion, sending a portion of the payload (e.g., the non-dropped portion) enables timely communication of data since less data is being transmitted (and any important information in the data may be retained, while non-essential chunks of data in the payload may be dropped or stored for later transmission). In one embodiment, the context may identify portions of the payload as chunks of data. This type of capability enhances network throughput and utilization. One implementation of qualitative communications for new IP is discussed in “A Framework for Qualitative Communications Using Big Packet Protocol,” Li, R. et al., NEAT'19: Proceedings Of The 2019 ACM Sigcomm Workshop On Networking For Emerging Applications And Technologies, pp. 22-28, ACM, 2019, the contents of which are hereby incorporated by reference. Additionally, the new IP contract can be utilized to carry the context of a qualitative packet. For example, in the contract specification for qualitative packets in new IP data packets, the following actions may be defined:
Wash: a generic operation to arbitrarily or selectively remove the bits/bytes inside the packet payload. For example, remove every 8th bit, remove every fifth byte, remove the last 10 bits, etc.
Repair and Recover: can fix the error bits/bytes in or salvage lost portions from the residual the packet payload based on context present along with the action.
Enrich: The packet payload may be inserted by the New IP node with locally cached chunks that match to the packet when the network condition becomes better to pass through the larger packet.

In one embodiment, qualitative communications apply random linear network coding, which is discussed in “In-Packet Network Coding for Effective Packet Wash and Packet Enrichment,” Dong, L., 2019 IEEE Globecom Workshop on Future Internet Architecture, Technologies and Services for 2030 and Beyond, and “Qualitative Communication Via Network Coding and New IP,” Dong, L., IEEE HPSR 2020, the contents of which are hereby incorporated by reference. In these discussions, the payload may be divided into multiple equal-sized chunks and applied with random linear network coding, such that the significance of each chunk does not differ. When qualitative processing is needed on the packet, the network node may initialize a random drop (or drop from the tail as many as needed) until the packet can be retained in the forwarding buffer.

Example Use Cases

ManyNets Addressing Schemes Using New IP Shipping Specification

The Internet is IP-based and connects devices and networks in a homogenous way. ManyNets is a combination of different kinds of network types, devices types, and infrastructure types. The new IP address format not only accommodates new addressing structures involving IoT type devices, but also the need for geographic address structures for networks involving satellites. In space-networks, Low-Earth Orbit (LEO) satellites become part of the forwarding path between the endpoints, and the location of the routers themselves is changing, unlike the case of terrestrial networks with stationary routers. Using conventional IP addresses is not sufficient from an end point's (or an adjacent network node's) perspective since it has to attach to the nearest satellite.

Time-Engineered Services Through New IP Contract Specification

New applications in both 5G and Network 2030, such as factory automation, remote operations, autonomous vehicles, or self-managing systems, are highly dependent on the precision of arrival and departure times of data over a network since these applications are machine-based. New IP provides a common framework through which each application can individually describe its' precise requirements. This is not currently possible with packet-based networks. Using high-precision (or time-engineered) services, every packet arrives at the destination within or at its specified time. New IP enables contract clauses on a per-packet basis to provide the capability of on-time, in-time guarantee or lossless type of packet delivery.

Additionally, one of the most important dimensions in 5G services is defined to be uRLLC. As the 5G radio stack has evolved, it has only been possible to support uRLLC between a 5G device and a base station. Using new IP, 5G mobile backhauls can support reliability and low latency over fixed packet networks as well.

Service Accountability

Service accountability refers to the determination of the causes on the network node when service guarantees are not met, or other policy violations occur. The new IP contract clauses can be updated or inserted into a new IP data packet for indicating failures.

Networks are a heterogeneous and non-deterministic system. Thus, congestion, outages, or different attack vectors impact the service level guarantees. It is essential to monitor and notify such violations to network operators to take corresponding actions. The new IP contract mechanism allows capturing violations on a per-packet, per-flow basis, which is especially useful in M2M latency-sensitive communications systems (since sending sensors do not expect or wait for the acknowledgment at the transport layer). Moreover, the network has to deliver the commands reliably, and in the case of a violation, the network should also be able to determine paths or nodes that caused violations.

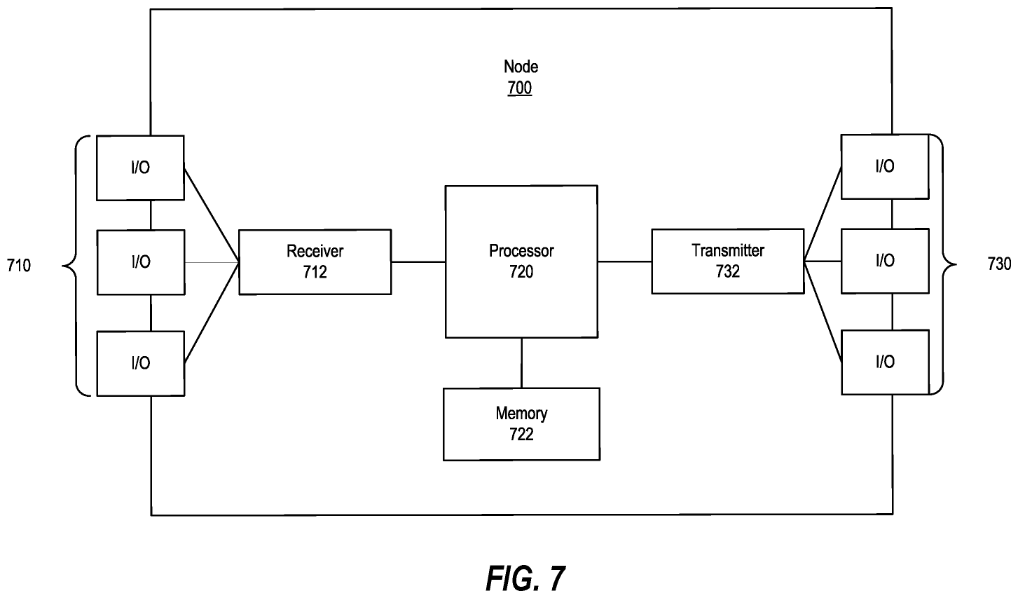

FIG. 7 illustrates an embodiment of a network node which may implement a router. The node (e.g., a router) 700 may be, for example, a node 110, 114, 120 or any other node or router as described above in communication system 100. The node 700 may comprise a plurality of input/output ports 710/730 and/or receivers (Rx) 712 and transmitters (Tx) 732 for receiving and transmitting data from other nodes, a processor 720 to process data and determine which node to send the data to and a memory. The node 700 may also generate and distribute data in the form of data packets in the communication system. Although illustrated as a single processor, the processor 720 is not so limited and may comprise multiple processors. The processor 720 may be implemented as one or more central processing unit (CPU) chips, cores (e.g., a multi-core processor), field-programmable gate arrays (FPGAs), application specific integrated circuits (ASICs), and/or digital signal processors (DSPs), and/or may be part of one or more ASICs. Moreover, the processor 720 may be implemented using hardware, software, or both. The memory 722 may be configured to store routing tables, forwarding tables, or other tables or information disclosed herein. Although illustrated as a single memory, memory 722 may be implemented as a combination of read only memory (ROM), random access memory (RAM), or secondary storage (e.g., one or more disk drives or tape drives used for non-volatile storage of data). The technology described above may also be implemented on any general-purpose network component, such as a computer or network component with sufficient processing power, memory resources, and network throughput capability to handle the necessary workload placed upon it.

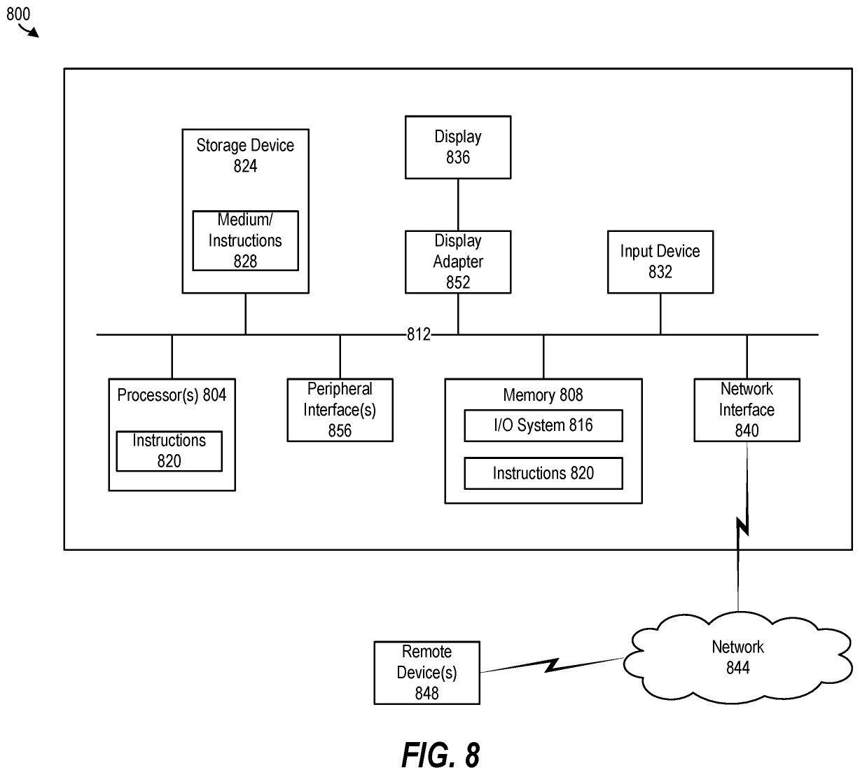

FIG. 8 shows an example embodiment of a computing system for implementing embodiments of the disclosure. Computer system 800 includes a processor 804 and a memory 808 that communicate with each other, and with other components, via a bus 812. Bus 812 may include any of several types of bus structures including, but not limited to, a memory bus, a memory controller, a peripheral bus, a local bus, and any combinations thereof, using any of a variety of bus architectures.

Memory 808 may include various components (e.g., machine-readable media) including, but not limited to, a random access memory component, a read only component, and any combinations thereof. In one example, a basic input/output system 816 (BIOS), including basic routines that help to transfer information between elements within computer system 800, such as during start-up, may be stored in memory 808. Memory 808 may also include (e.g., stored on one or more machine-readable media) instructions (e.g., software) 820 embodying any one or more of the aspects and/or methodologies of the present disclosure. In another example, memory 808 may further include any number of program modules including, but not limited to, an operating system, one or more application programs, other program modules, program data, and any combinations thereof.

Computer system 800 may also include a storage device 824. Examples of a storage device (e.g., storage device 824) include, but are not limited to, a hard disk drive, a magnetic disk drive, an optical disc drive in combination with an optical medium, a solid-state memory device, and any combinations thereof. Storage device 824 may be connected to bus 812 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 824 (or one or more components thereof) may be removably interfaced with computer system 800 (e.g., via an external port connector (not shown)). Particularly, storage device 824 and an associated machine-readable medium 828 may provide nonvolatile and/or volatile storage of machine-readable instructions, data structures, program modules, and/or other data for computer system 800. In one example, software 820 may reside, completely or partially, within machine-readable medium 828. In another example, software 1120 may reside, completely or partially, within processor 804.

Computer system 800 may also include an input device 832. In one example, a user of computer system 800 may enter commands and/or other information into computer system 800 via input device 832. Examples of an input device 832 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 832 may be interfaced to bus 812 via any of a variety of interfaces (not shown) including, but not limited to, a serial interface, a parallel interface, a game port, a USB interface, a FIREWIRE interface, a direct interface to bus 812, and any combinations thereof. Input device 832 may include a touch screen interface that may be a part of or separate from display 836, discussed further below. Input device 832 may be utilized as a user selection device for selecting one or more graphical representations in a graphical interface as described above.

A user may also input commands and/or other information to computer system 800 via storage device 824 (e.g., a removable disk drive, a flash drive, etc.) and/or network interface device 840. A network interface device, such as network interface device 840, may be utilized for connecting computer system 800 to one or more of a variety of networks, such as network 844, and one or more remote devices 848 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 844, may employ a wired and/or a wireless mode of communication. In general, any network topology may be used. Information (e.g., data, software 820, etc.) may be communicated to and/or from computer system 800 via network interface device 840.

Computer system 800 may further include a video display adapter 852 for communicating a displayable image to a display device, such as display device 836. Examples of a display device include, but are not limited to, a liquid crystal display (LCD), a cathode ray tube (CRT), a plasma display, a light emitting diode (LED) display, and any combinations thereof. Display adapter 852 and display device 836 may be utilized in combination with processor 804 to provide graphical representations of aspects of the present disclosure. In addition to a display device, computer system 800 may include one or more other peripheral output devices including, but not limited to, an audio speaker, a printer, and any combinations thereof. Such peripheral output devices may be connected to bus 812 via a peripheral interface 856. Examples of a peripheral interface include, but are not limited to, a serial port, a USB connection, a FIREWIRE connection, a parallel connection, and any combinations thereof.

It is understood that the present subject matter may be embodied in many different forms and should not be construed as being limited to the embodiments set forth herein. Rather, these embodiments are provided so that this subject matter will be thorough and complete and will fully convey the disclosure to those skilled in the art. Indeed, the subject matter is intended to cover alternatives, modifications and equivalents of these embodiments, which are included within the scope and spirit of the subject matter as defined by the appended claims. Furthermore, in the following detailed description of the present subject matter, numerous specific details are set forth in order to provide a thorough understanding of the present subject matter. However, it will be clear to those of ordinary skill in the art that the present subject matter may be practiced without such specific details.

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

The computer-readable non-transitory media includes all types of computer readable media, including magnetic storage media, optical storage media, and solid-state storage media and specifically excludes signals. It should be understood that the software can be installed in and sold with the device. Alternatively the software can be obtained and loaded into the device, including obtaining the software via a disc medium or from any manner of network or distribution system, including, for example, from a server owned by the software creator or from a server not owned but used by the software creator. The software can be stored on a server for distribution over the Internet, for example.

Computer-readable storage media (medium) exclude (excludes) propagated signals per se, can be accessed by a computer and/or processor(s), and include volatile and non-volatile internal and/or external media that is removable and/or non-removable. For the computer, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

For purposes of this document, each process associated with the disclosed technology may be performed continuously and by one or more computing devices. Each step in a process may be performed by the same or different computing devices as those used in other steps, and each step need not necessarily be performed by a single computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for data communication in a network, comprising:
receiving, by a node in the network, an internet protocol (IP) data packet, the IP data packet having a header and a payload;
performing, by the node, an action on the IP data packet based on specifications in the header of the IP data packet; and
forwarding, by the node, the IP data packet based on the specifications in the header of the IP data packet to a next hop node in the network.

2. The method of claim 1, wherein the data packet has a format including a header field and the specifications, and
the specifications include a shipping specification field, a contract specification field and a payload specification field.

3. The method of claim 2, wherein each of the shipping specification field, the contract specification field and the payload specification field are independently variable in length.

4. The method of claim 2, wherein the header field specifies an offset of the shipping specification field, an offset of the contract specification field, an offset of the payload specification field, and a length of the payload.

5. The method of claim 2, wherein the shipping specification field specifies one or more address format types, a source address (SA) field and a destination address (DA) field, wherein the SA and DA fields specify at least one of a length of the address, a type of communication and the SA and DA.

6. The method of claim 5, wherein the length of the address of the SA and DA is variable.

7. The method of claim 2, wherein
each contract specification field includes one or more contract clauses, and
each contract clause includes at least one of an event and a condition, and an action.

8. The method of claim 7, further comprising executing the action in the contract upon occurrence of the event specified in the contract clause and when the condition specified in the contract clause is satisfied.

9. The method of claim 8, wherein
the contract clause includes the event, the condition and the action;
the event indicates the occurrence or state of a node in the network that impacts behavior of the network;
the condition indicates one or more logical operators to perform a conditional check upon occurrence of the event; and
the action indicates a delivery time of the IP data packet communicated between a source and a destination.

10. The method of claim 9, wherein the payload specification field specifies a differentiated value or property corresponding to portions of the payload.

11. The method of claim 10, wherein the action corresponds to an operation performed on the payload based on the differentiated value or property in the payload specification.

12. The method of claim 11, wherein the property specifies a relationship between different portions of the payload.

13. The method of claim 12, further comprising performing the action on portions of the payload according to the condition and the action and the property corresponding to portions of the payload in the contract clause.

14. The method of claim 10, wherein
the property specifies the differentiated value corresponding to the portions of the payload, and
the property includes a flag that indicates that the action has been performed on one or more of the portions of the payload.

15. A node for communicating data in a network, comprising:
a non-transitory memory storage comprising instructions; and
one or more processors in communication with the memory, wherein the one or more processors cause the node to execute the instructions to:
receive an internet protocol (IP) data packet, the IP data packet having a header and a payload;
perform an action on the IP data packet based on specifications in the header of the IP data packet; and
forward the IP data packet based on the specifications in the header of the IP data packet to a next hop node in the network.

16. The node of claim 15, wherein the data packet has a format including a header field and the specifications, and
the specifications include a shipping specification field, a contract specification field and a payload specification field.

17. The node of claim 16, wherein the header field specifies an offset of the shipping specification field, an offset of the contract specification field, an offset of the payload specification field, and a length of the payload.

18. The node of claim 16, wherein the shipping specification field specifies one or more address format types, a source address (SA) field and a destination address (DA) field, wherein the SA and DA fields specify at least one of a length of the address, a type of communication and the SA and DA.

19. The node of claim 18, wherein
each contract specification field includes one or more contract clauses, and
each contract clause includes at least one of an event and a condition, and an action.

20. A non-transitory computer-readable medium storing computer instructions for data communications in a network, that when executed by one or more processors, cause the one or more processors to perform the steps of:
receiving, by a node in the network, an internet protocol (IP) data packet, the IP data packet having a header and a payload;
performing, by the node, an action on the IP data packet based on specifications in the header of the IP data packet; and
forwarding, by the node, the IP data packet based on the specifications in the header of the IP data packet to a next hop node in the network.
